(19) United States
(12) Patent Application Publication
(10) Pub. No.: US 2024/0005422 A1
(43) Pub. Date: Jan. 4, 2024

(54) COLLABORATIVE REAL ESTATE SYSTEM AND METHOD

(71) Applicant: Huckleberry Al, Inc., Waterloo (CA)

(72) Inventor: Mossab Basir, Waterloo (CA)

(21) Appl. No.: 18/208,696

(22) Filed: Jun. 12, 2023

Related U.S. Application Data
(60) Provisional application No. 63/351,114, filed on Jun. 10, 2022.

(51) Int. Cl. G06Q 50/16; G06Q 30/0204

(52) U.S. Cl. CPC G06Q 50/16; G06Q 30/0205; G06Q 30/0206

(57) ABSTRACT

A method and system for collecting and sharing real estate listings and home related content from a web browser, web application or mobile application. A browser extension or mobile app permits a user to save selected real estate listings on an account at a remote server. The user can then review all of the saved real estate listings in a personalized summary page, share the page with others, and get feedback from others. The server may suggest additional listings to the user based upon the saved selections and may learn from the user's reaction to the suggested listings.

### BACKGROUND

Conventional browsing of real estate listings and home related content may allow the use of in-site and in-app bookmarking methods that can save and assign content to a user's profile such as ‘favoriting,’ ‘liking,’ bookmarking and ‘saving’ content directly inside of the website or application. These methods limit the user from an opportunity to consolidate their bookmarked content across multiple sites and applications into one place or view. This fragments and scatters content, which may be relevant to one browsing or research activity such as buying a new home across multiple real estate listings sites.

Furthermore, this creates a challenge for users looking to share and collaborate on selected content with their partners and real estate agents. Users must rely on manual and tedious methods (i.e.: save website URL's into a spreadsheet, etc.) to save and track listings they have liked.

### SUMMARY

In some aspects, the techniques described herein relate to a computing system including: at least one processor; storage storing a computer program which when executed by the at least one processor performs operations: a) creating a user account; b) receiving a request over a network to save a real estate listing to the user account; and c) in response to operation b), saving information relating to the real estate listing to the user account.

In some aspects, the techniques described herein relate to a method including: a) receiving with at least one processor a request over a network to save a real estate listing to a user account; b) in response to step a), saving information relating to the real estate listing to the user account, wherein the information includes at least one photo, a listing price, and a URL c) the at least one processor retrieving updated information directly from the URL and updating the information in the user account.

### BRIEF DESCRIPTION OF THE DRAWINGS

FIG. 1 is a high level schematic of a network in which the features of the present invention are implemented.

FIG. 2 shows one example implementation in a web browser.

FIG. 3 shows one example implementation as an app on a mobile device.

FIG. 4 shows an example implementation of a personalized summary page on a web browser.

FIG. 5 shows an example implementation of a personalized summary page on an app on a mobile device.

FIG. 6 shows a share screen implemented in the app when the computing device 20 is a mobile device.

FIG. 7 shows an example listings feed screen as implemented as an app on a mobile device.

FIG. 8 is a flowchart of some of the aspects of the method performed by the at least one server.

### DETAILED DESCRIPTION

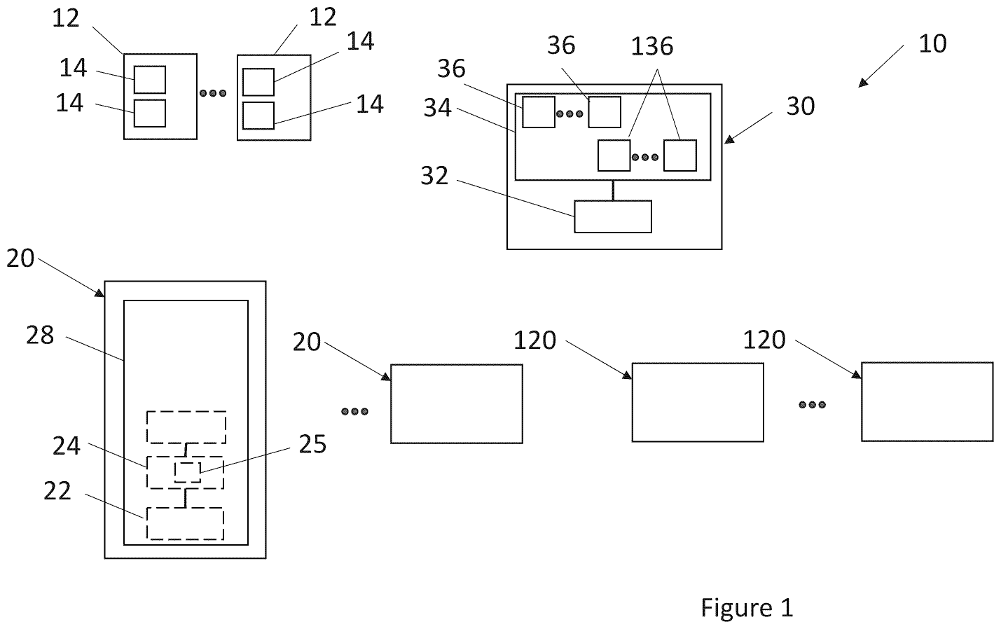

FIG. 1 shows a computer network 10, such as the Internet. As is well-known, a plurality of servers 12 each having many processors and vast amounts of storage are connected on the network 10 and provide access to a plurality of hosted websites 14. In this example, the hosted websites 14 are real estate websites, each containing a plurality of listings for real estate, such as real estate being offered for sale, including residential homes.

As is also known, a user can access these plurality of hosted websites 14 on the network 10 using a computing device 20, which may be a computer, mobile device (such as a smart phone or tablet), etc. The computing device 20 includes at least one processor 22 (more likely, a plurality of processors) and electronic storage 24 storing data and programs which when executed by the at least one processor perform the functions described herein, including a program 25, which may be an app or a browser extension. The computing device 20 also includes a communication device 26, such as a network card, cell data circuit, wifi circuit, or any other wired or wireless hardware that provides communication on the network 10. The computing device 20 also includes a user interface 28, such as a touchscreen or display, keyboard, mouse, microphone, or any combination of these.

Of course, there would be many such users using many such computing devices 20 to access other accounts 36. Additionally, there may be a plurality of agent computing devices 120 (again, each with at least one processor, storage with suitable programming, etc., also in the form of a web browser and/or app—same as computing devices 20). Each agent may have an associated account 136 also stored in storage 34 on the at least one server 30.

In the present invention, at least one server 30 also communicates with the computing device 20 over the network 10. The at least one server 30 includes at least one processor 32 (and more likely a plurality of processors) and storage 34 storing data and programs which when executed by the at least one processor 32 perform the functions described herein. The at least one server 30 may include physically or virtually separate servers at different locations, each performing the same or different subsets of the functions described herein. The storage 34 in the at least one server 30 stores a plurality of accounts 36, each associated with a different user and/or a different computing device 20.

The program 25 on the computing device 20 may be a web browser extension or a stand-alone app. A web browser extension is a code package that can be installed into a browser and/or client device (e.g., computer) running a browser. The extension may add a new feature to a browser, extend an existing functionality, modify a visual theme, and so on.

Once installed on the computing device 20, the browser extension may logically and/or physically become part of a browser and thus the bookmarking functionality as it relates to the invention may become part of the browser functionality.

The invention can be implemented as a browser extension or as an app (for a computer or mobile device).

The user adds the program 25, i.e. either the extension (for a browser) or downloads the app on the computing device 20. The user creates an account 36 on the at least one server 30 (e.g. in the cloud). The program 25 communicates with the at least one server 30. The user would access the same user account 36 on the at least one server 30 whether using the browser extension or via the app. The user may access the same user account 36 on the at least one server 30 from more than one computing device 20.

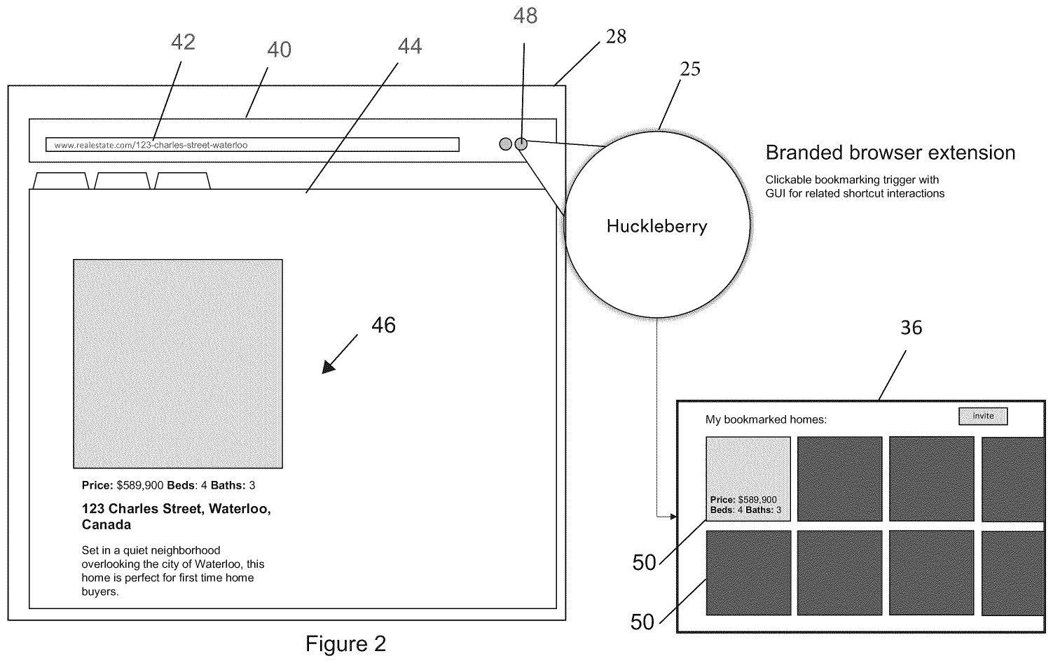

FIG. 2 shows one example implemented as a browser extension. The functionality would be the same when implemented as an app.

Referring to FIG. 2, the user interface 28 of the computing device 20 displays a web browser window 40 displaying an address bar 42 and a web page 44 from one of the plurality of hosted websites 14. The program 25 (in this case, the browser extension) is configured to recognize listings data 46 on the current webpage and enable the user to bookmark the web page 44 and the page's content, by simply clicking the extension button 48 in the browser window 40. This action would trigger a record 50 created in the user account 36 on the at least one server 30. The record 50 includes certain content from the listings data 46 on the web page 44 such as the property's address, listing ID, price, photo of the house, etc. as well as unique identifiers to the originating source of the page such as the URL or web address of the content (e.g. from address bar 42). The program 25 (here, browser extension) also scans the web page 44 for additional metadata about the listing including keywords such as: bungalow, fixer upper, renovated, back yard, etc. The program 25 also creates a preview of the listing, via a thumbnail. The program 25 records the list date (i.e., how long it has been on the market) and the property type. All this information is stored in a record 50 in a database on the at least one server 30 and assigned to the user account 36.

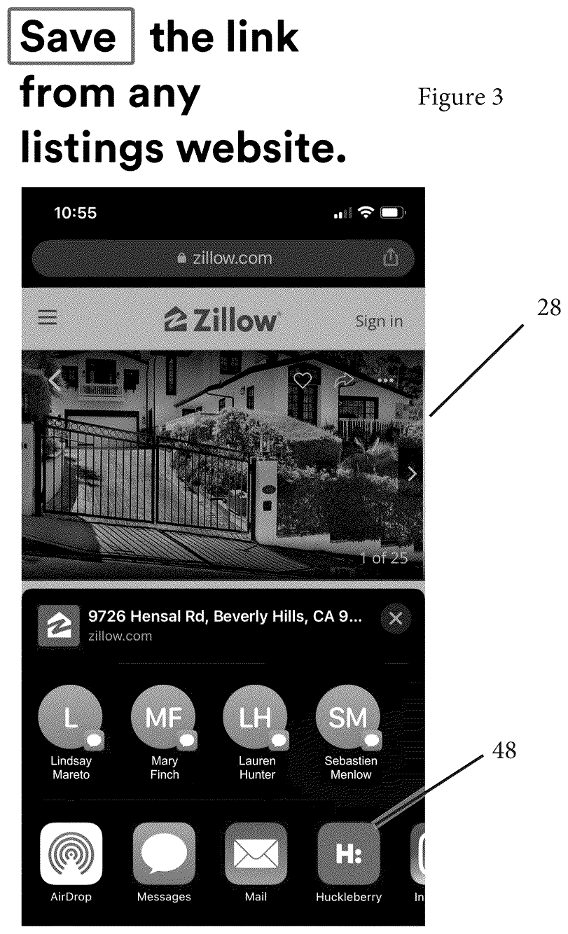

FIG. 3 shows an example where the program 25 is implemented as an app when the computing device 20 is a mobile device. The user can view a listing on a browser or dedicated app (e g Zillow) and the button 48 can be activated by the user to save the current listing to the user's account 36, as before.

Bookmarked content in the user's account 36 would then be organized and displayed inside of a webpage and/or app for further interactions as described below.

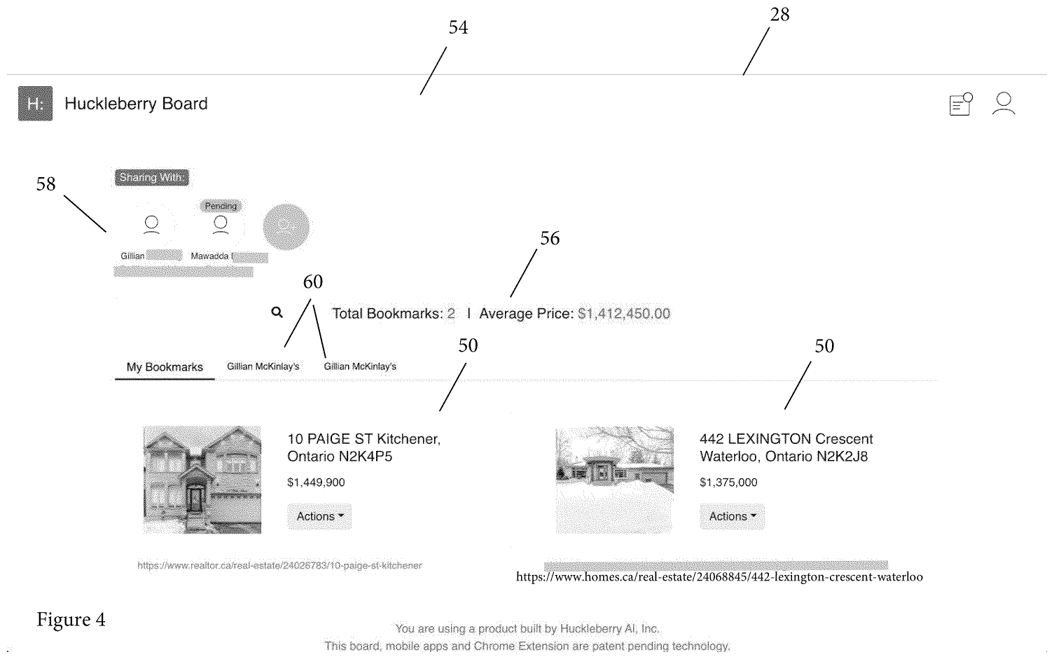

The user can view all of the saved listings together on a personalized summary page 54 on the user interface 28, as shown in FIG. 4. Again, the personalized summary page 54 is either a browser page or a page in the app. The summary data (address, price and url) on this screen is pulled from the records 50 that were saved in the user's account 36 on the at least one server 30. Although only two listings are shown in FIG. 4, there would usually be many (e.g. 10 or 100 or more) saved listings and they could be from many different listings websites (again, 10 or 100 or more).

Additionally, the personalized summary page 54 may display summary information 56, such as total number of bookmarks and average listing price. The personalized summary page 54 may also provide the ability to share the personalized summary page 54 with other users and to indicate the other accounts 58 with whom this personalized summary page 54 is shared. Likewise, the personalized summary page 54 may provide shared tabs 60 in which other users' personalized summary page 54 can be viewed by this user.

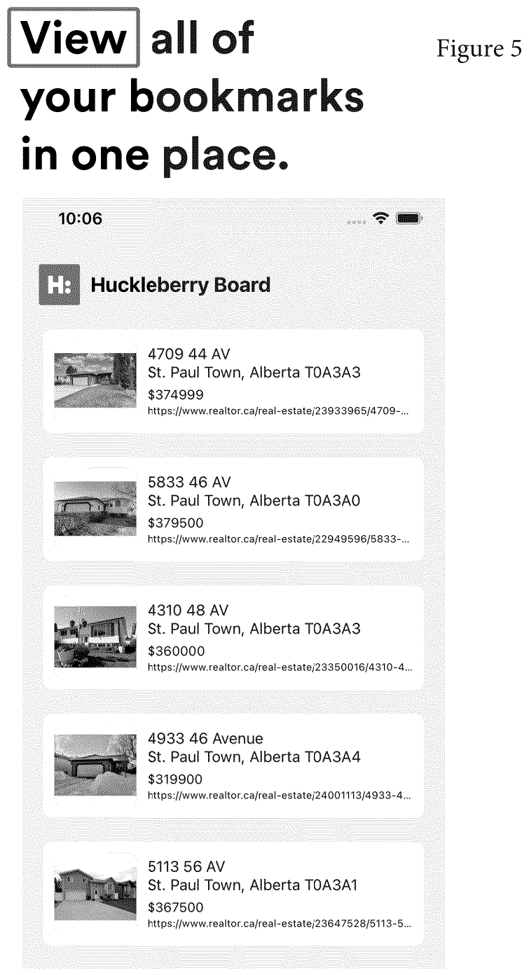

FIG. 5 shows the personalized summary page 54 implemented in the app when the computing device 20 is a mobile device.

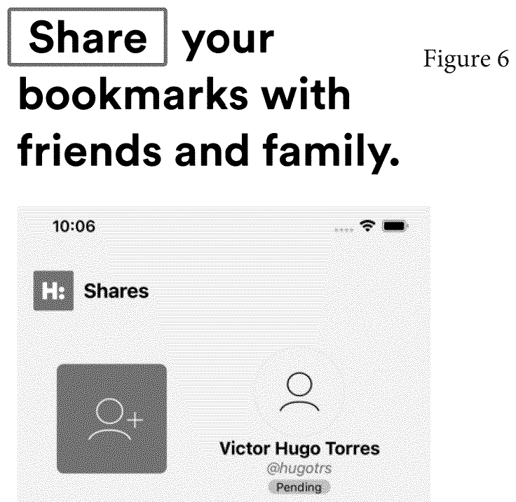

FIG. 6 shows a share screen implemented in the app when the computing device 20 is a mobile device. The user can choose other users with whom to share the personalized summary page 54.

Even when the user is not currently using the program 25, the at least one server monitors all the property listings by scanning the saved pages of the plurality of hosted websites 14 on a periodic basis (e.g. daily). The information in the record 50 stored on the at least one server 30, including price, status (e.g. sold, pending, for sale, removed), is updated. The at least one server 30 would discover deltas related to price, or whether it is still on the market.

Further interactions between users and the page may include:

1. inviting collaborators and viewers

2. voting and scoring bookmarked content

3. commenting

4. filtering and sorting

5. dynamically organizing content into categorical boards

Content and attributes in the records 50 can be analyzed from a single and a collective of the bookmarked content in order to produce derivative insights and value to the user as well as to other prospective stakeholders. Content and attributes about the property include size, bedrooms, baths, location, other dimensions, acreage, other descriptors.

A collaborator is a user that is co-shopping with the primary user (e.g. spouse or other intended co-owner), and also providing access to their own favorites via a ‘share my board’ function.

Each user that is invited to the board, can upvote or downvote a bookmarked listing (functionality is based on a sum of the total votes). Invited users can add comments that would appear below each respective saved listing, under expandable text that says ‘comments.’

The user can filter and sort by price, votes, recency.

The user can dynamically organize content into categorical boards.” The user can name specific boards, such as home ideas, new homes, investment properties, vacation properties, furniture ideas, etc.

Some analysis, scoring and derivatives related to the bookmarked content is displayed on the browser via the browser extension. The analysis, scoring and derivatives may be created by machine learning based analysis. Derivatives could be outputs using the raw data to create useful data products like a determination of ‘fair price’ relative to other market figures, or ‘great location’ using geospatial data about the bookmarked content.

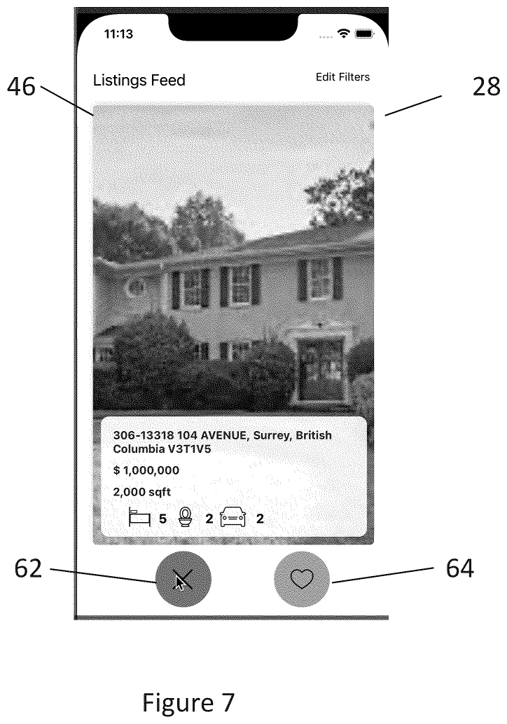

FIG. 7 shows a listings feed screen displayed on the user interface 28 of the computing device 20, again via a web browser or via the app. The at least one server 30 chooses new listings data 46 of particular listings based upon the records 50 in the user's account 36 and displays the listings data 46 to the user. For example, the at least one server 30 may choose other listings in the same general geographic area and within a certain percentage listing price of the records 50 in the user's account 36. As the user saves more records 50, the at least one server 30 may get more specific, including number of bedrooms, home size, etc.

The at least one server 30 presents these listings to the user on the user interface 28 one at a time. The user may react to the presented listing negatively with a negative reaction button 62 (or by swiping the listing image left) or may react to the presented listing positively with a positive reaction button 64 (or by swiping the listing image to the right). Using machine learning, for example, the at least one server 30 learns more about what the user is looking for from the positive and negative reactions by the user and can use this learned information to choose additional new listings to present to the user. This learned information is associated with the user's account 36. The at least one server 30 may save the “liked” listings as saved records 50 in the user's account 36 with the rest of the saved records or separately.

Referring again to FIG. 1, an agent user, such as a real estate agent, can use one of the plurality of agent computing devices 120 to access the at least one server 30 via the network 10 (again using an app or web browser). The at least one server 30 presents the agent with the option to purchase information regarding the user accounts 36. For example, an agent may purchase on a monthly basis an exclusive right to receive information about users who show sufficient interest in homes in a particular zip code or city or other geographic area. Alternatively, the agent may request users who show sufficient interest in homes in a particular geographic area and within a certain price range. This information is saved in the agent's associated account 136 on the at least one server 30.

The at least one server 30 measures the level of interest demonstrated by each account 36 based upon information such as one or more of the following: number of homes viewed, number of homes saved, whether the account 36 has been shared to other users (and to how many other users), the frequency with which the user accesses the account 36, etc. Once a user reaches a threshold level of interest (such as, at least eight homes saved, or at least four homes saved and accessed more than four times, or at least three homes saved and shared with at least one other user, etc.) the at least one server 30 may share information from the user's account 36 to an agent who has purchased the relevant geographic area during the relevant period of time. The information that is shared to the agent may include: contact information, geographic area of interest, price level of interest, home size, lot size, and other property attributes of interest, such as big backyard, Victorian style, etc.

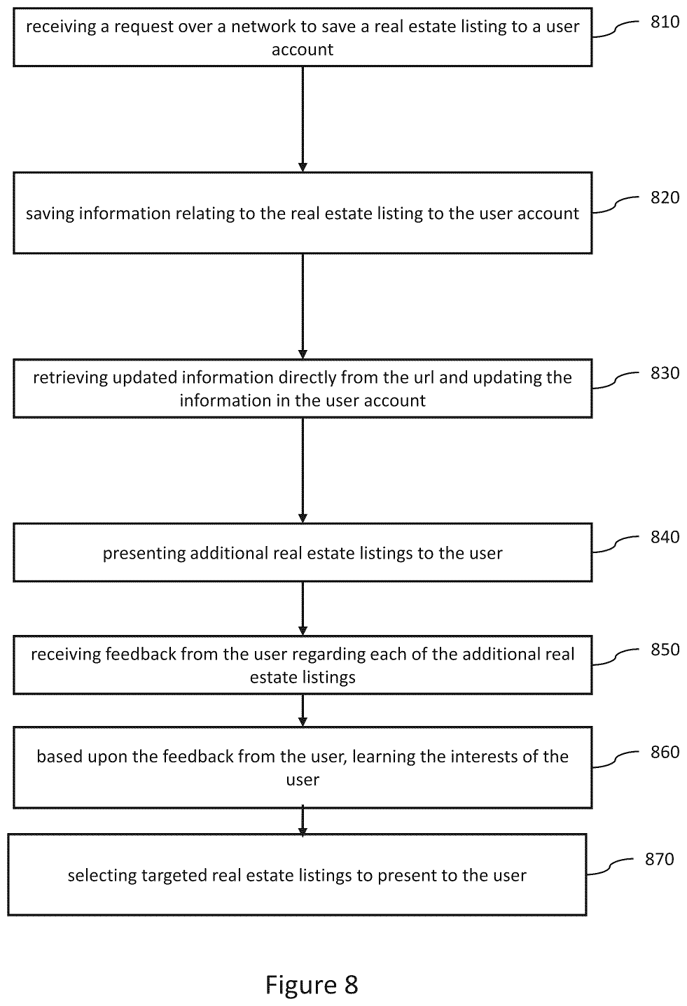

FIG. 8 is a flowchart of some of the aspects of the method performed by the at least one server 30, already described generally above. At step 810, the at least one server 30 receives a request over a network to save a real estate listing to a user account.

At step 820, the at least one server 30 saves information relating to the real estate listing to the user account.

At step 830, the at least one server 30 retrieves updated information directly from the URL and updates the information in the user account. This is performed periodically, e.g. once or twice a day.

At step 840, the at least one server 30 presents additional real estate listings to the user. At step 850, the at least one server 30 receives feedback from the user regarding each of the additional real estate listings.

At step 860, based upon the feedback from the user, the at least one server 30 learns the interests of the user; and based upon the learned interests, the at least one server 30 selects targeted real estate listings to present to the user.

“Electronic storage” or “storage” as used herein means a non-transitory computer-readable medium of any type. The term “non-transitory,” as used herein, is a limitation of the medium itself (i.e., tangible, not a signal) as opposed to a limitation on data storage persistency (e.g., RAM vs. ROM).

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claim steps are for ease of reference in dependent claims only and do not signify a required sequence of steps unless other explicitly recited in the claims.

What is claimed is:

1. A computing system comprising:
at least one processor;
storage storing a computer program which when executed by the at least one processor performs operations:
a) creating a user account for a user;
b) receiving a request from the user over a network to save a real estate listing to the user account; and
c) in response to operation b), saving information relating to the real estate listing to the user account.

2. The computing system of claim 1 wherein the information includes at least one photo and a listing price.

3. The computing system of claim 2 wherein the information includes a URL.

4. The computing system of claim 3 wherein the operations further include:
d) retrieving updated information directly from the URL and updating the information in the user account.

5. The computing system of claim 4 wherein the operations further include:
e) presenting additional real estate listings to the user; and
f) receiving feedback from the user regarding each of the additional real estate listings.

6. The computing system of claim 5 wherein the operations further include:
g) based upon the feedback from the user, learning what features are of interest to the user; and
h) based upon operation g), selecting targeted real estate listings to present to the user.

7. The computing system of claim 6 wherein the operations further include:
i) presenting the targeted real estate listings to the user;
j) receiving feedback from the user regarding each of the targeted real estate listings; and
k) based upon the feedback from the user in operation j), learning what features are of interest to the user.

8. The computing system of claim 1 wherein the operations further include:
d) repeating operations b) and c), wherein the real estate listing is one of a plurality of real estate listings; and
e) presenting the plurality of real estate listings to the user.

9. The computing system of claim 8 wherein the plurality of real estate listings are each on a different one of a plurality of websites.

10. The computing system of claim 9 wherein the operations further include:
f) receiving a request to share the plurality of real estate listings to at least one other user; and
g) in response to operation f), presenting the plurality of real estate listings to the at least one other user.

11. The computing system of claim 1 wherein the operations further include:
d) repeating operations b) and c);
e) determining a geographic region of interest based upon the information saved to the user account; and
f) based upon the determined geographic region of interest, sending contact information regarding the user to an agent account associated with the geographic region of interest.

12. A computerized method including:
a) receiving with at least one processor a request over a network to save a real estate listing to a user account;
b) in response to step a), saving information relating to the real estate listing to the user account, wherein the information includes at least one photo, a listing price, and a URL; and
c) the at least one processor retrieving updated information directly from the URL and updating the information in the user account.

13. The computerized method of claim 12 further including:
d) the at least one processor presenting additional real estate listings to the user;
e) the at least one processor receiving feedback from the user regarding each of the additional real estate listings;
f) based upon the feedback from the user, the at least one processor learning interests of the user; and
g) based upon step f), selecting targeted real estate listings to present to the user.

14. The computerized method of claim 12 further including:
d) repeating steps a) and b), wherein the real estate listing is one of a plurality of real estate listings;
e) based upon the saved real estate listings, the at least one processor learning interests of the user; and
f) based upon the interest of the user learned in step e), the at least one processor
presenting additional real estate listings to the user.

15. The computerized method of claim 12 further including:
d) repeating operations b) and c), wherein the real estate listing is one of a plurality of real estate listings, wherein the plurality of real estate listings are each on a different one of a plurality of websites.

16. The computerized method of claim 12 further including:
d) wherein the real estate listing is one of a plurality of real estate listings, the at least one processor receiving a request to share the plurality of real estate listings to at least one other user; and
e) in response to operation d), the at least one processor presenting the plurality of real estate listings to the at least one other user.

17. The computerized method of claim 12 further including:
d) repeating steps a) and b), wherein the real estate listing is one of a plurality of real estate listings;
e) the at least one processor determining a geographic region of interest based upon the information saved to the user account;
f) based upon the determined geographic region of interest, the at least one processor sending contact information regarding the user to an agent account associated with the geographic region of interest.
